(19) United States
(12) Patent Application Publication
(10) Pub. No.: US 2015/0032900 A1
(43) Pub. Date: Jan. 29, 2015

(54) SYSTEM FOR SEAMLESSLY SWITCHING BETWEEN A CLOUD-RENDERED APPLICATION AND A FULL-SCREEN VIDEO SOURCED FROM A CONTENT SERVER

(71) Applicants: Spencer Shanson, Menlo Park, CA (US); Viresh Prashar, Springfield, VA (US)

(72) Inventors: Spencer Shanson, Menlo Park, CA (US); Viresh Prashar, Springfield, VA (US)

(21) Appl. No.: 14/374,191

(22) PCT Filed: Feb. 15, 2013
(86) PCT No.: PCT/US13/26459

§ 371 Date: Jul. 23, 2014

Related U.S. Application Data
(60) Provisional application No. 61/713,248, filed on Oct. 12, 2012.
(60) Provisional application No. 61/599,358, filed on Feb. 15, 2012.

(30) Foreign Application Priority Data
Jan. 23, 2013 (US) PCT/US2013/022812

(51) Int. Cl. H04N 21/238

(52) U.S. Cl. CPC H04N 21/238
USPC 709/231

(57) ABSTRACT

A system and method for seamlessly integrating efficient digital content media streaming with a flexible browsing interface for display on a viewing device. The invention relates to rendering an interface in a remote interface display on a remote server and streaming that remote interface display as a data stream to an appliance coupled to a viewing device. The remote display could include digital media content streaming from a content delivery network (CDN). The invention also relates to enabling the appliance to stream digital media content directly from the CDN and to seamlessly display that streaming content on the viewing device.

### CROSS-REFERENCE TO RELATED APPLICATION

This application is entitled to the benefit of and claims priority to: U.S. Provisional Application 61/590,207, filed on Jan. 24, 2012; U.S. Provisional Application 61/599,358, filed on Feb. 15, 2012; U.S. Provisional Application 61/713,248, filed on Oct. 12, 2012; and PCT Application PCT/US13/22812 filed on Jan. 23, 2013; all of which are included by reference as if fully set forth herein.

### TECHNICAL FIELD

The technical field is digital communication.

### BACKGROUND ART

With the advent of digital video, and the explosion of content now available via the Internet and other means, allowing a viewer to more efficiently find, discover, and watch compelling media content is essential. The Internet provides an extraordinary delivery infrastructure. Nevertheless, individuals often prefer to view video content on their televisions rather than their computers.

Companies like TiVo, Comcast, DirecTV, and Netflix have struggled to find ways to innovate content discovery and delivery mechanisms while allowing the content to be accessible on as many types of devices as possible, including legacy devices such as televisions. Existing approaches often rely on the presence of a “set-top-box”, or other appliance to provide a “thick” interface between content and viewer. Innovations in interfaces and other means to find and discover compelling content are difficult to deploy because they require updating the device (e.g., the software, firmware, etc.). This can be expensive to test, deploy, and troubleshoot. It also likely requires supporting multiple in-use versions across multiple platforms which increases costs.

What is needed is a technology to allow faster and cheaper deployment of improvements in searching and discovering compelling video content on one's television.

### SUMMARY OF THE INVENTION

The present invention discloses a system and method relating to efficiently finding, discovering, and watching video content.

In the most basic embodiment, the viewer provides input or instructions to a client device or “appliance”. Typically this input is provided via an infrared (IR) remote control device, but could be any input device (e.g., keyboard, mouse, gesture interpretation, voice command, etc.). The appliance relays the input to a remote server over a computer network. The remote server responds to the input by creating or changing a remote interface display running on the remote server (e.g., a remote web browser or other application that can emit audio data or video data). As the remote interface display changes, the changes are transmitted via a data stream to the appliance. The appliance displays the data stream via a viewing device, like a television, home theater system, etc. The data stream could contain audio, video, or other (e.g., instructional) data. Modernly, the appliance is often integrated directly inside the viewing device.

By way of example, in one embodiment, the viewer enters input via an IR remote control to manipulate a cursor in the remote interface display to “focus on” a button, textual “link”, or other onscreen virtual control referencing a particular episode of a television show. The instruction is received by the appliance and transmitted to the remote server. The remote server changes the remote interface display to highlight the selection of the onscreen virtual control. The updated remote interface display streams as video data to the appliance. The appliance displays the change on the viewing device.

The viewer then enters another input to select that show for viewing. That instruction is transmitted to the remote server. The remote server changes the remote interface display to indicate the selection, and plays a sound providing audio feedback to the user confirming the show selection. The remote server then streams digital media content representing the show. The changes in the remote interface display, the sound, and the streaming digital media content are transmitted via the data stream to the appliance as audio and video data. The appliance displays them via the viewing device.

As such, the viewer would effectively control the behavior of the remote server and the remote interface display via inputs. The viewer would experience the results of the input on the viewing device. Obviously, the above are very simple examples. More complex interactions involving layering audio across multiple channels as well as providing animated video feedback are likely present in most embodiments.

Note that in other embodiments, inputs are not required to arrive at the remove server from the appliance, but could just as easily come from another source. For example, the remote server could provide a web interface so that a viewer away from the home could instruct the remote server to stream content to the appliance in the home. In another example, the remote server could provide an API by which the viewer could schedule delivery of digital media content at some time in the future (e.g., via a smart phone “app”). These are just two of many potential configurations where inputs may arrive from sources other than the appliance.

In another embodiment, a portion of the remote interface display contains continually streaming audio and video. An example of this would be previewing digital media content in a portion of the remote interface display. For example, a viewer could move a cursor over an onscreen control referencing a particular movie. As the cursor is moved to the onscreen control, related digital media content is streamed in another portion of the remote interface display. Related digital media content could include a trailer or preview for that movie, an advertisement for a product that appeared in the movie, even the movie itself, etc. The entire remote interface display, including the cursor, onscreen controls, etc., as well as the audio and video from the streaming related digital media content is transmitted in the data stream to the appliance for display on the viewing device. Once the user selects the movie for viewing “full screen”, the data stream substantially comprises the streaming digital media content representing the movie.

In such an embodiment, the remote server often streams digital media content, such as previews, trailers, advertisements, television shows, movies, etc. from another source such as a content server or a content delivery network (CDN). This means that in response to receiving instructions from the appliance, the remote server streams the desired digital media content from the content server, decodes and displays it on a portion of the remote interface display (or all of the remote interface display in the case of full screen viewing), encodes the audio and video from the remote interface display, including the audio and video from the streaming digital media content, and sends the re-encoded stream to the appliance for display on the viewing device. Note that the digital media content is streamed to and decoded by the remote server where it is re-encoded and streamed again to the appliance that decodes the resulting stream for display.

There is an optimization to be made. In yet another embodiment, the appliance is instructed to stream the digital media content directly from the content server, rather than have it pass through the remote server. As described above, the viewer provides input to trigger the streaming of digital media content. Upon receiving the input, the remote server transmits an instruction to the appliance to stream the digital media content from the content server and display it in a portion of or over the entire viewing device. In the case where the instruction is to stream the digital media content in a portion of the viewing device, the appliance merges the two streams (the remote interface display data stream from the remote server and the streaming digital media content from the content server) before display. Different configurations allow for different ways for the remote server to transmit such an instruction to the appliance. For example, in one embodiment, the instruction could be sent asynchronously to the client. In another, the instruction could be included in the data stream. In yet another, the client could periodically poll the remote server for instructions.

Note that combinations of the aforementioned embodiments are possible. For example, the remote server streams digital media content from the content server and integrate it into its data stream for transmission to the appliance when it occupies a small portion of the remote display, but then instruct the appliance to stream the digital media content directly from the content server in full screen mode. This provides the ability for the remote server to filter, augment, or modify the digital media content before it is streamed to the appliance in one context, but allow it to be streamed unmodified in another. For example, in one mode, the remote server displays pricing information, trivia about the content in a “ticker”, a “watermark”, etc., superimposed on the streaming digital media content when it is intended to occupy a portion of the screen. Once the viewer selects full screen viewing, the remote server instructs the appliance to stream the digital media content directly from the content server.

In another embodiment, the remote server sends instructions to the appliance to stream digital media content from the content server starting at an arbitrary time code. For example, the remote server could provide an interface where a viewer has the option to start watching desired content on a portion of the remote display, but later has the option to switch to full screen viewing. If the digital media content being streamed in the portion of the remote display comes through the data stream of the remote server (as described above), but comes directly from the content server in full screen mode, it would be undesirable for the viewer to have to replay the digital media content from the very beginning upon switching viewing modes. Instead, upon receiving an instruction from the appliance to switch to full screen mode, the remote server transmits in the data stream an instruction for the appliance to start streaming the digital media content directly from the content server starting at time t, where time t coincides approximately to the time code of the digital media content most recently incorporated into the data stream by the remote server in a portion of the remote interface display. The net effect is a seamless way to integrate efficient streaming content delivery with a flexible interface using a relatively simple appliance.

Other embodiments include audio continuity improvements, such as those disclosed in U.S. Provisional Application 61/590,207 and PCT Application PCT/US13/22812 mentioned above.

### BRIEF DESCRIPTION OF THE DRAWINGS

FIG. 1 depicts one embodiment wherein a remote server constructs a remote interface display via a browser which includes digital media content streaming from a CDN, and then transmits the remote interface display to an appliance as a data stream.

FIG. 2 depicts one embodiment wherein a remote server constructs a remote interface display wherein the entirety of the remote interface display is occupied by digital media content streaming from a CDN (i.e., full screen mode), and then transmits the remote interface display to an appliance as a data stream.

FIG. 3 depicts one embodiment wherein a remote server instructs an appliance to stream digital media content from a CDN starting at a time code.

FIGS. 4 & 5 depict flow diagrams of embodiments wherein viewers request to stream digital media content, where the streamed content is first rendered on the remote interface displays of the remote servers and transmitted to appliances as data streams, but is then streamed directly from the CDNs by the appliances.

FIG. 6 depicts a remote interface display containing a multiplicity of digital media content streaming from one or more CDNs.

FIG. 7 is an architectural diagram of one embodiment of the invention.

### DESCRIPTION OF THE EMBODIMENTS

The following describes preferred embodiments. However, the invention is not limited to those embodiments. The description that follows is for purpose of illustration and not limitation. Other systems, methods, features and advantages will be or will become apparent to one with skill in the art upon examination of the following figures and detailed description. It is intended that all such additional systems, methods, features and advantages be included within this description, be within the scope of the inventive subject matter, and be protected by the accompanying claims.

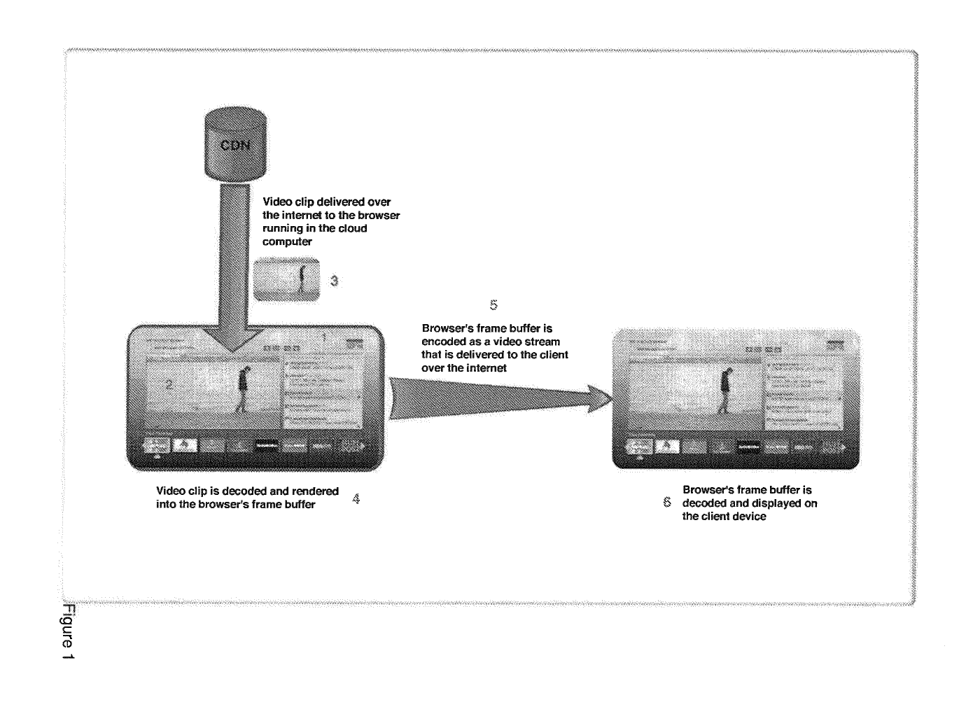

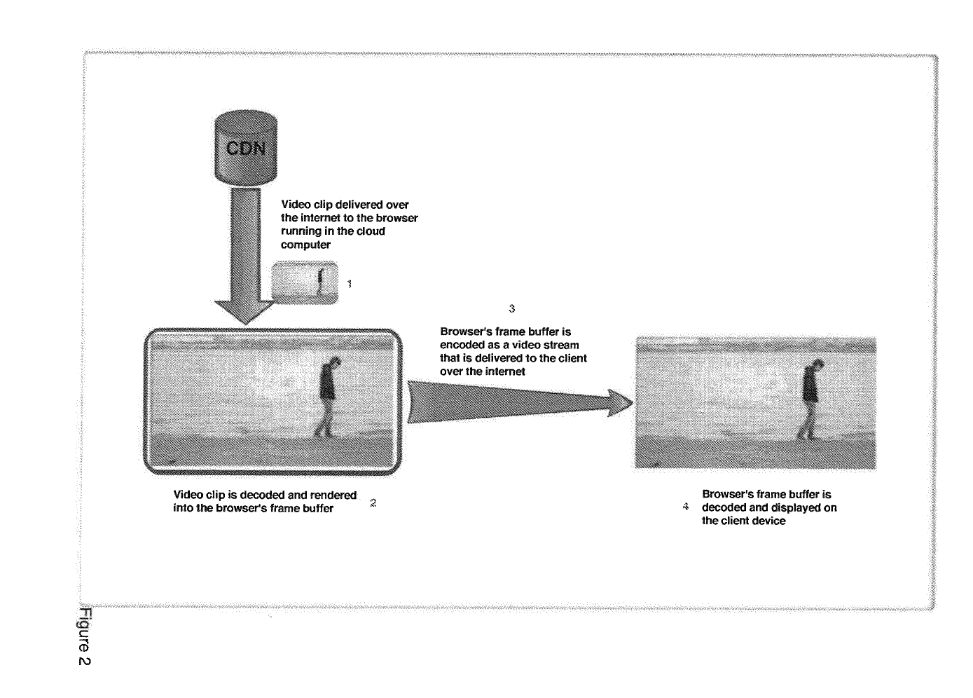

FIG. 1 depicts a remote server 1 constructing a remote interface display 2, which—as depicted—is a browser 3, but could be any application that has a graphical or audio interface. The browser 3 includes digital media content 4 streaming from a CDN 5 to the remote server 1 over a computer network 9. The remote server 1 encodes and transmits the remote interface display 2 to an appliance 6 as a real time low latency data stream 7 over a computer network 10. Note that computer networks 9 and 10 may be different computer networks, or they may be the same network (e.g., the Internet).

In a typical embodiment such as the one depicted in the drawings, a user or viewer 14 interacts with the remote server 1 by sending an input 12, typically via an input device 16. The input device 16 is typically an IR remote control device 17 or a network-connected device 18 such as an iPhone or iPad. When the viewer 14 sends the input 12 (e.g., by pressing a button on the remote control device 17), the input 12 is sent to the remote server 1. In the case of the remote control device 16, the input 12 is typically transmitted to the remote server 1 via the appliance 6, which receives the initial input 12. Alternatively, the input 12 is transmitted directly from the network-connected device 18. The remote server 1 reacts to the input 12 and updates the remote interface display 2. Updates to the remote interface display 2 are encoded and transmitted to the appliance 6 via the data stream 7.

As depicted in FIG. 1, the remote interface display 2 comprises a browser 3. The browser 3 renders the interface, including the digital media content 4. In the depicted example, a reference to the digital media content 4 stored in the CDN 15 is embedded in a page 20 being displayed by the browser 3 using an HTML <video> tag. As the browser 3 streams the digital media content 4 from the CDN 15 over the computer network 9, it is decoded and rendered into a framer buffer 19 associated with the browser 3. The entire frame buffer 19, along with any corresponding audio output is encoded as a single data stream 7 and transmitted over the computer network 10 to the appliance 6. The appliance 6 receives the data stream 7 from the remote server 1 and decodes and displays the data stream 7.

It is worth noting that the invention can easily leverage advances in streaming technologies and digital media encodings to improve the experience of the viewer 14. The data stream 7 and the digital media content 4 could make use of any available encoding or delivery mechanism appropriate to the circumstance. As inexhaustive examples, they could include audio data, video data, both, multiple interleaved channels of each (e.g., more than one video channel for 3D or unique multiviewer perspective content), etc. They could be of fixed or variable bitrates. As mentioned above, they could take advantage of other delivery inventions such as that described in U.S. Provisional Application 61/590,207 and PCT Application PCT/US13/22812. Delivery of either or both streams could make use of adaptive bitrate technologies such as Apple's HTML Live Streaming (HLS), MPEG DASH, or Microsoft's SmoothStream technologies, where the bitrate may change in response to environmental conditions like measured connection latency, throughput, etc.

It is also worth noting that the invention's process by which digital media content 4 is transmitted to the appliance 6 can also benefit from advances in CDN technology. In traditional CDNs—like Akamai, for example—data is replicated among many content servers. When a client—like the appliance 6—wants to retrieve digital media content 4 present on a traditional CDN 5, the client is directed to a single content server where a copy of the digital media content 4 resides. The client retrieves all of the digital media content 4 associated with that request from a single content server. The specific content server is selected at the time of the request using some heuristic (e.g., geographical proximity to the consumer, available bandwidth, etc.).

The traditional CDN 5 described above would certainly work with the invention. However, the appliance 6 could also make use of a peer-to-peer network type CDN (not depicted), where subsets or portions of the data are replicated across many participating entities, and where the number of entities, and the portions of data they possess are relatively dynamic (see, e.g., BitTorrent). In that type of environment, the appliance 6 retrieves portions of the desired digital media content 4 from one or more of those entities and reassembles the portions before display. Those entities could be content servers, but they could also be similar appliances 6, or even other types of participants in the peer-to-peer network. In addition to consuming the digital media content 4, the appliance 6 may also participate as an entity providing the portions of the data it recently received.

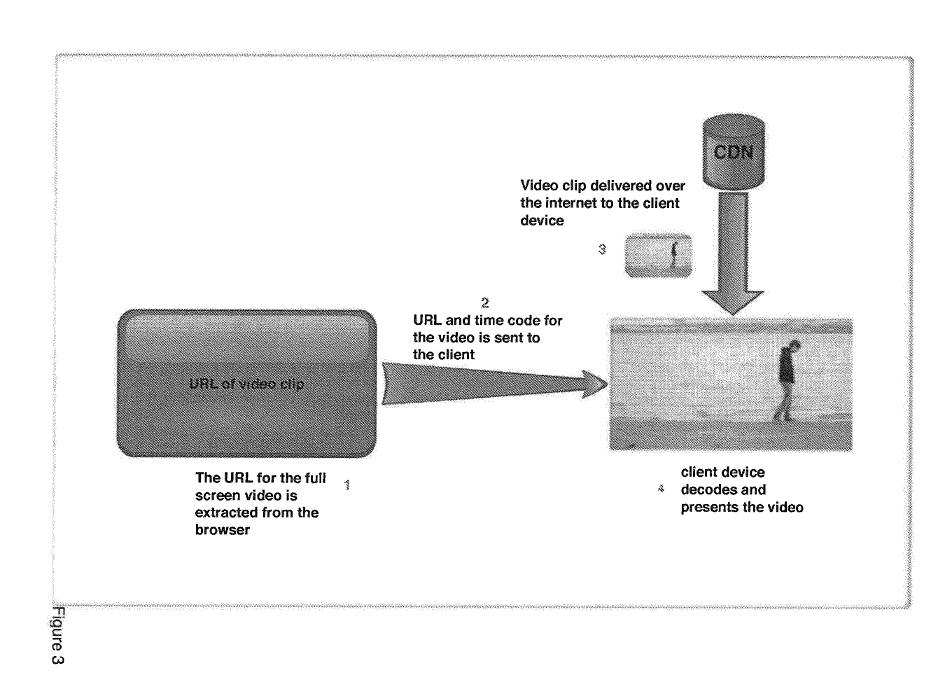

FIG. 2 depicts the remote server 1 constructing the remote interface display 2 wherein the entirety of the remote interface display 2 is occupied by the digital media content 4 (i.e., full screen mode) streaming from the CDN 5 over the computer network 9. As in FIG. 1, the remote server 1 transmits the remote interface display 2 to the appliance 6 as a data stream 7 over the computer network 10.

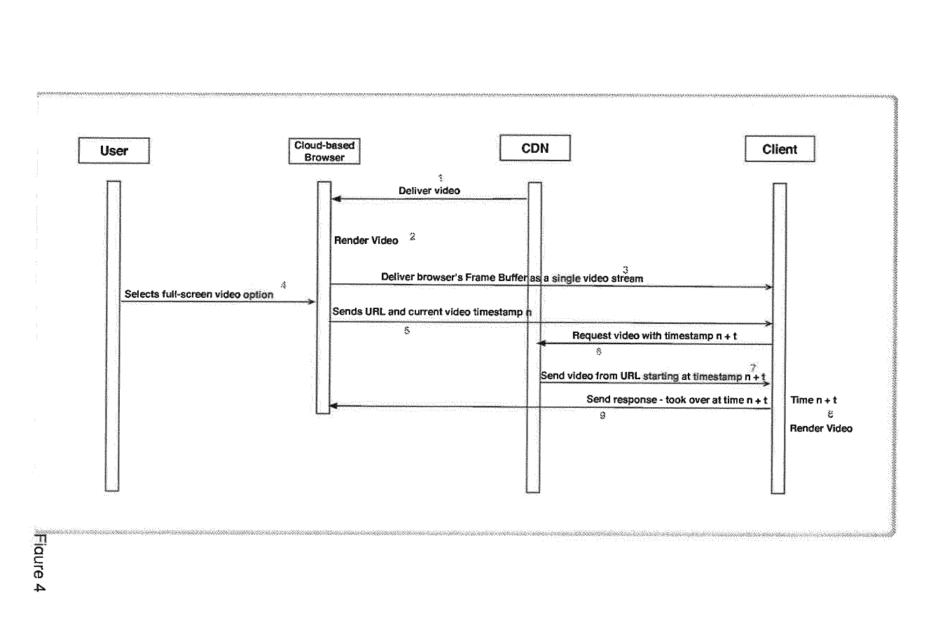

FIG. 3 depicts an optimization wherein the remote server 1 instructing the appliance 6 to stream digital media content 4 from the CDN 5 starting at a time code 8. The appliance 6 requests the digital media content 4 from the CDN 5 over computer network 11. Note that computer networks 9, 10, and 11 may be different computer networks, or they may be the same network (e.g., the Internet).

As depicted, when the remote server 1 receives the input 12 indicating that the viewer 14 desires displaying the digital media content 4 in full screen mode, the remote server 1 sends a universal resource identifier (URI) for the digital media content 4 to the appliance 6 along with an instruction 13. The appliance 6 stops streaming and decoding the data stream 7 from the remote server 1, and starts streaming and decoding the digital media content 4 directly from the CDN 15, which it displays on the viewing device 21 (e.g., as depicted, in full screen mode).

The instruction 13 optionally includes a time code 8 to allow the appliance 6 to start streaming the digital media content 4 from the CDN 15 at a specific point. For example, if the digital media content 4 has not yet been rendered to the remote interface display 2, then the remote server 1 can send the URI of the digital media content 4 on the CDN 15 with a time code 8 of zero seconds. If a portion of the digital media content 4 has already been rendered via the remote interface display 2, then the remote server 1 includes the time that the appliance 6 should take over playback by streaming, decoding, and displaying the digital media content 4 directly from the CDN 15.

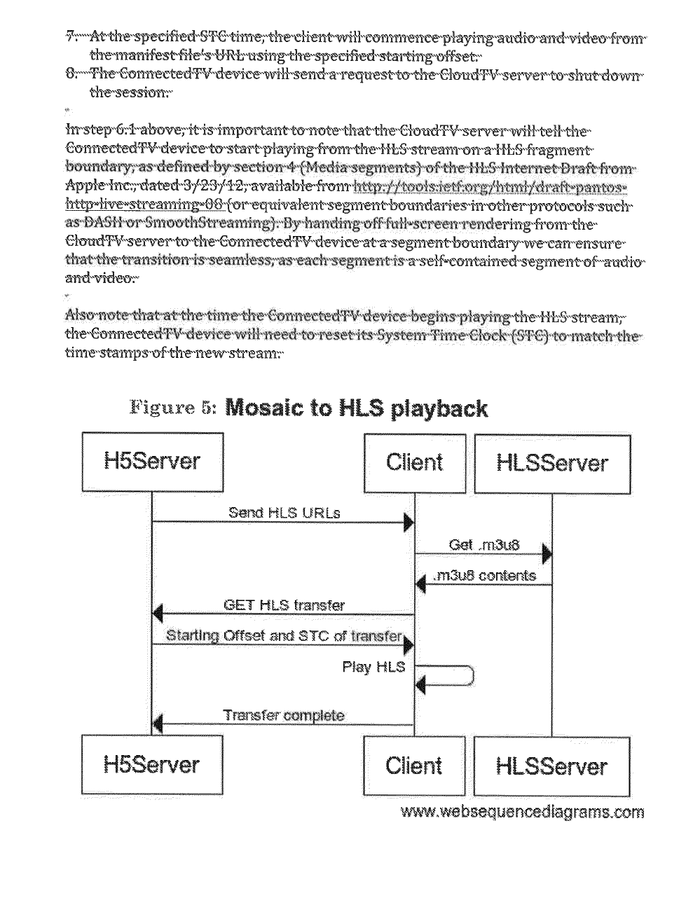

FIG. 4 depicts a flow diagram allowing the appliance 6 to take over playback in a seamless manner. Generally, the remote server 1 transmits an instruction 13 with a time code 8 indicating the point during playback at which the appliance 6 should take over streaming and decoding the digital media content 4 directly from the CDN 15. The appliance 6 ultimately makes the determination as to the specific point at which the switch actually happens, but the remote server 1 continues in its current mode until informed by the appliance 6 that the handoff has been completed.

In the depicted embodiment, a viewer 14 requests to stream digital media content 4. The streamed content 4 is first streamed to the remote server 1 over the computer network 9. The remote server 1 renders the streamed content 4 on the remote interface display 2. As in FIGS. 1-2, the remote interface display 2 is then transmitted over the computer network 10 to the appliance 6 as a data stream 7. The viewer 14 then provides input 12 that is transmitted to the remote server 1. By way of example, the input 12 could include a request 15 to view the content in full screen mode. Upon receipt of the input 12, the remote server 1 transmits an instruction 13 to the appliance 6 over the computer network 10 to stream digital media content 4 from the CDN 5 starting at a time code 8. The appliance 6 requests the digital media content 4 from the CDN 5 to start at time code 8. The CDN 5 begins streaming the digital media content 4 starting at time code 8 directly to the appliance 6 over the computer network 10. The appliance 6 renders the streaming digital media content 4 for the viewer 14.

The time code 8 could be chosen to provide some overlap with what has already been streamed via the data stream 7. Any overlap could be ignored or played by the appliance 6. Alternatively, the appliance 6 could add an offset (t) to the time code 8 (n), and retrieve the digital media content 4 located at the URI, starting at (n+t). When the presentation timestamp of the stream reaches time (n+t), the appliance 6 ceases displaying the data stream 7 from the remote server 1 and instead displays the digital media content 4 located at the URI. Optionally, the appliance 6 can send a response back to the remote server 1 to indicate that the appliance has taken over playback, and the remote server 1 can pause transmission of its generated data stream 7 to the appliance 6.

Between sending the instruction 13 to the appliance 6 to take over playback, and receiving confirmation from the appliance 6 that playback has been taken over, the remote server 1 must continue rendering the digital media content 4 and transmitting the data stream 7 to the appliance 6 for display. Optionally, the remote interface display 2 can render a message or provide other feedback to the viewer 14 that the switch is happening.

The offset (t) is calculated by the appliance 6 so as to be able to seamlessly switch from the data stream 7 and the digital media content 4 located at the URI. In one illustrative example, the client caches audio packets that are transmitted in advance of corresponding video packets in such a way that the end of an audio packet aligns with the last frame of a group of pictures (GOP). The appliance 6 can therefore determine at what point to start streaming the digital media content 4 located at the URI, knowing that the audio it receives from the URI aligns with the end of its cached audio buffers, and that the video associated with that stream will start with a key frame.

Note that there exist alternative ways that the appliance 6 might be directed from which source (i.e., the remote server 1 or the CDN 5) to retrieve the digital media content 4 at any given time. FIG. 5 depicts one such alternative approach. In FIG. 5, rather than the appliance 6 receiving an instruction from the remote server 1 to start retrieving the digital media content 4 from the CDN 5, the appliance 6 periodically polls the remote server 1 to ask from which source the digital media content 4 should be streamed. The remote server 1 may respond in a number of ways to optimize the experience for the viewer 14. Inexhaustive examples include: no response or a basic NULL response (i.e., no change); a signal for the appliance 6 to speed up or slow down its polling interval; a signal for the appliance 6 to retrieve the desired digital media content 4 (possibly at a given time code 8) from the CDN 5; a signal for the appliance 6 to retrieve the desired digital media content 4 from the remote server 1 via the data stream 7, etc.

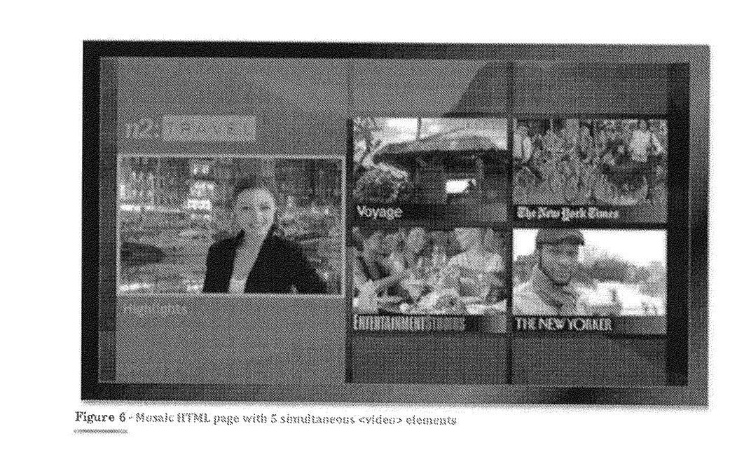

FIG. 6 depicts an example of a remote interface display 2 that contains a multiplicity of digital media content 4 streaming from one or more CDNs 5.

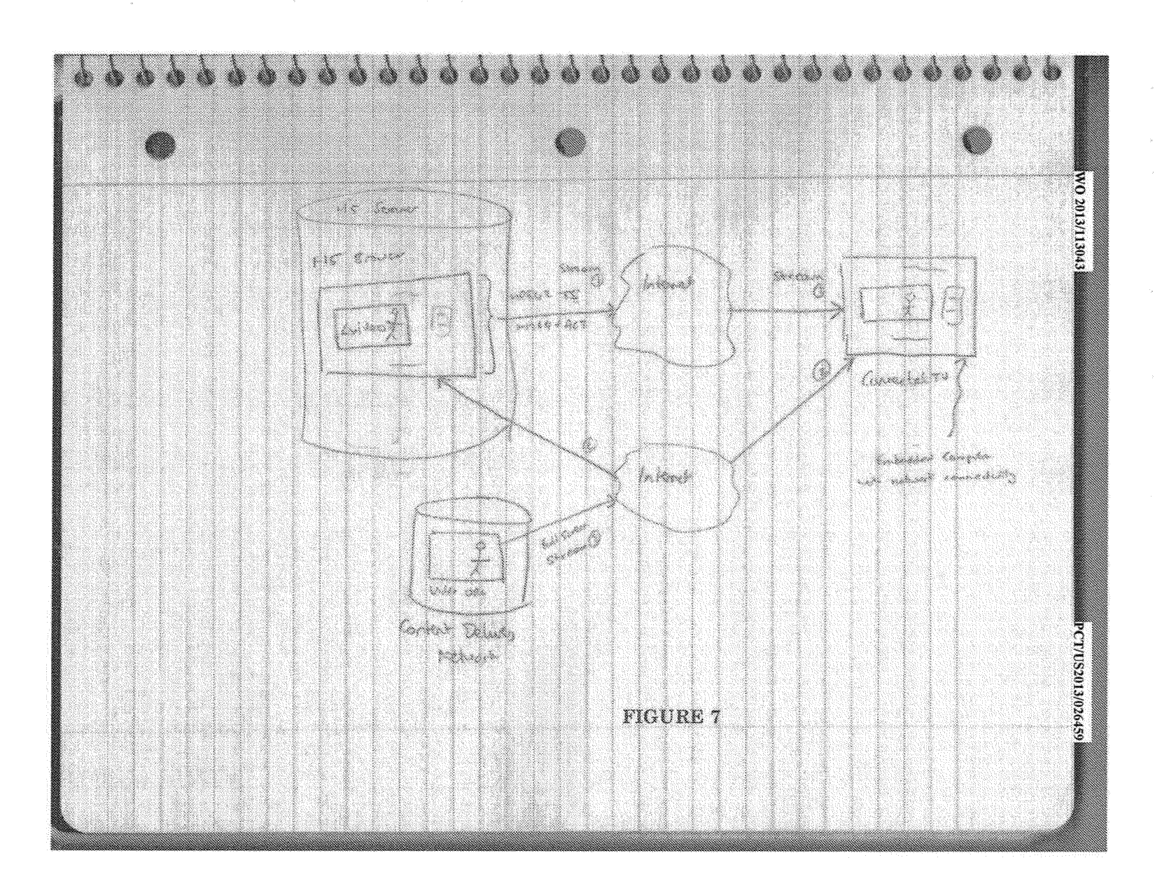

FIG. 7 is an architectural diagram of one embodiment of the invention. The remote server 1 comprises a remote interface display 2 and is coupled to the appliance 6 via a computer network 10. The remote server 1 is coupled to the CDN 5 via a computer network 9. The remote interface display 2 comprises streaming digital media content 4 that originates from the CDN 5 via the computer network 9. The remote interface display 2 is encoded as a data stream 7 that is transmitted to the appliance 6 over computer network 10. The appliance 6 is coupled to the CDN 5 via a computer network 11. The appliance receives digital media content 4 from the CDN 5 via the computer network 11. As depicted, computer networks 9, 10, are the same network (i.e., the Internet).

### INDUSTRIAL APPLICABILITY

The invention pertains to data streaming for remote display.

What is claimed is:

1. A system for streaming digital media content from a content delivery network (CDN) over a computer network to a viewing device by way of a remote server and an appliance comprising:
a. a computer network;
b. a CDN coupled to the computer network, the CDN comprising:
i. digital media content;
c. a remote server coupled to the CDN via the computer network, the remote server comprising:
i. a remote interface display comprising:
A. audio data or video data;
wherein the remote server:
ii. receives instructions via the computer network;
iii. streams the digital media content from the CDN;
iv. updates the remote interface display to include the digital media content; and
v. streams the audio data or video data from the updated remote interface display over the computer network to an appliance;
d. an appliance coupled to the remote server via the computer network, wherein the appliance:
i. streams audio data or video data from the remote server; and
ii. displays the streaming audio data or video data on the viewing device; and
e. the viewing device coupled to the appliance.

2. The system of claim 1 wherein:
a. the remote server:
i. transmits instruction data to the appliance, the instruction data comprising:
A. a location of the digital media content in the CDN; and
B. a time code; and
b. the appliance:
i. receives the instruction data;
ii. streams a portion of the digital media content starting at the time code from the location in the CDN; and
iii. displays the streaming digital media content on the viewing device.

3. A method for streaming digital media content comprising:
a. receiving on a remote server instructions via a computer network;
b. streaming digital media content from a content delivery network (CDN) via the computer network;
c. updating a remote interface display to include the streaming digital media content;
d. streaming audio data or video data from the updated remote interface display over the computer network to an appliance;
e. receiving on the appliance the streaming audio data or video data from the remote server; and
f. displaying the streaming audio data or video data on the viewing device.

4. The method of claim 3 further comprising:
a. transmitting instruction data to the appliance, the instruction data comprising:
i. a location of the digital media content in the CDN; and
ii. a time code;
b. receiving on the appliance the instruction data from the remote server;
c. streaming a portion of the digital media content starting at the time code from the location in the CDN; and
d. displaying the streaming content on the viewing device.
